(19) United States
(12) Patent Application Publication
(10) Pub. No.: US 2013/0284278 A1
(43) Pub. Date: Oct. 31, 2013

(54) Chemical Tank Adapter and Method of Use

(71) Applicant: Craig V. Winborn, Odessa, TX (US)

(72) Inventor: Craig V. Winborn, Odessa, TX (US)

(21) Appl. No.: 13/928,997

(22) Filed: Jun. 27, 2013

Related U.S. Application Data
(60) Provisional application No. 61/810,019, filed on Apr. 9, 2013.

(51) Int. Cl. F16L 15/00

(52) U.S. Cl. CPC F16L 15/00
USPC 137/15.01; 137/544; 137/565.01; 137/561 R

(57) ABSTRACT

A chemical tank adapter for connecting a chemical injection pump system to a chemical tank is disclosed herein. The disclosed adapter generally comprises a novel connection member including a body, a first arm extending perpendicularly from a rear face of said body, and a second arm extending obliquely from a bottom face of said body. The disclosed adapter may further include one or more valves and an elbow member.

### CROSS-REFERENCE TO RELATED APPLICATIONS

This application is related to and claims priority from earlier filed U.S. Provisional Patent Application No. 61/810,019, filed Apr. 9, 2013, the disclosure of which is incorporated herein by reference.

### BACKGROUND OF THE INVENTION

1. Field of the Invention

The present invention generally relates to a chemical tank adapter and method of use. More specifically, the present invention relates to an adapter for connecting a chemical injection pump system to a chemical tank.

2. Description of Related Art

Hydraulic fracturing is widely used in the oil and gas industry to enhance recovery of oil and natural gas. Commonly known as “fracking,” hydraulic fracturing is the propagation of fractures in a rock layer by a pressurized fluid. Hydraulic fractures are formed by drilling wellbores into reservoir rock formations and injecting large volumes of fracking fluid, primarily consisting of water, under high pressure into the wellbores. The injected fluid creates fractures in the rock formations, allowing oil or natural gas to flow from the formations to the wellbores.

Various chemicals are mixed with the fracking fluid prior to injection. Chemicals serve many functions in hydraulic fracturing. From limiting the growth of bacteria to preventing corrosion of the well casing, chemicals are needed to insure that the fracturing job is efficiently and effectively performed.

Undiluted hydraulic fracturing chemicals are initially stored in chemical tanks. The chemicals are then injected into the fracking fluid at a selected rate using a chemical injection pump system. Design problems in current systems used for connecting a chemical injection pump system to a chemical tank present several disadvantages that are overcome by the present invention.

Current systems utilize multiple pipe fittings to fluidly connect a chemical tank to a chemical injection pump and to a gauge device for measuring the injection rate of the chemical injection pump. One problem with current systems, however, is that such systems for fluidly connecting a chemical injection pump to a chemical tank are time-consuming and labor intensive. The pipe fittings currently utilized have threaded ends (i.e., ends having internal female threads or external male threads) for assembling the fittings together in various configurations. Therefore, much time and effort is spent trying to properly thread the various pipe fittings together in an effort to make leak-proof, reliable connections between the fittings.

A further problem with current systems is that each threaded connection point between the pipe fittings is a potential leak path. Ideally, when threading the fittings together, internal female threads mate with external male threads to form an impenetrable barrier against fluids. In reality, complete metal-to-metal contact between the male and female threads is extremely difficult to achieve and any minute spaces left in between the threads become leak paths. This is a serious problem faced by the oil and gas industry as surface leaks of undiluted chemicals used in hydraulic fracturing result in waste of expensive chemicals and pose great risks to the environment and human health.

Another problem with current systems is the unnecessary stress placed upon chemical tanks due to the use of heavy pipe fittings designed to handle pressurized fluids. Pipe fittings designed to handle pressurized fluids are not required for connecting a chemical injection pump to a chemical tank because the chemicals flowing from the chemical tank to the chemical injection pump are not pressurized. The chemicals do not become pressurized until after the chemicals flow through the chemical injection pump. Therefore, current pipe fittings have thicker and studier walls and, thus, weigh more than required for handling non-pressurized fluids, such as the fluids flowing from the chemical tank to the chemical injection system. As a result of the added weight and stress placed upon chemical tanks by current systems, the current systems decrease the life span of chemical tanks.

Currently, a one-piece adapter is needed to reduce the number of pipe fittings, threaded connection points, and leak paths between the chemical tank and the chemical injection system. Furthermore, in order to decrease the labor costs associated with assembling current systems, an adapter is needed that provides for a quick and efficient method of connecting a chemical injection pump system to a chemical tank by eliminating the time spent threading pipe fittings together. An adapter having fewer leak paths is needed in order to decrease the waste, cost, environmental risks, and human health risks associated with chemical leaks. Finally, a device is needed that is compact and relatively lightweight in order to decrease the stress put on chemical tanks by the heavy pipe fittings currently used, thereby increasing the life span of chemical tanks.

In view of the foregoing, it is apparent that a need exists in the art for a chemical tank adapter which overcomes, mitigates or solves the above problems in the art. It is a purpose of this invention to fulfill this and other needs in the art which will become more apparent to the skilled artisan once given the following disclosure.

### OBJECTS AND SUMMARY OF THE INVENTION

It is an object of the present invention to overcome the above described drawbacks associated with current devices. To achieve these and other advantages and in accordance with the purpose of the invention, as embodied and broadly described, the present disclosure describes a chemical tank adapter for connecting a chemical injection pump system to a chemical tank.

The chemical tank adapter disclosed herein includes a novel one-piece connection member. By utilizing this one-piece connection member, the disclosed device provides an adapter having a reduced number of fittings, a reduced number of threaded connection points, and a reduced number of leak paths. Furthermore, the connection member may be formed as a single unit with one or more valve members and an elbow member to further reduce the number of fittings, threaded connection points, and leak paths. This configuration provides many advantages over current assemblies used to connect a chemical injection system to a chemical tank.

Unlike existing systems used to connect a chemical injection system to a chemical tank, the present adapter is not comprised of multiple threaded pipe fittings that must be threadably connected to one another at the work site. The present adapter provides for a quick and easy installation method and saves time and labor costs by significantly reducing the number of threaded connection points between the chemical tank and the chemical injection system.

Current assemblies provide leak paths at each threaded connection point between the numerous pipe fittings used to connect the chemical injection system to the chemical tank. By eliminating many of the threaded connection points and leak paths, the configuration of the disclosed adapter greatly reduces the waste resulting from chemical leaks and decreases the environmental and human health risks associated with chemical leaks.

Furthermore, unlike current assemblies that utilize pipe fittings designed to handle pressurized fluids, the disclosed adapter is designed to handle the non-pressurized chemicals flowing by gravity from the chemical tank to the chemical injection pump. Therefore, the disclosed adapter is designed to be more compact and to have thinner walls and a reduced weight compared to current assemblies.

These, together with other objects of the invention, along with various features of novelty that characterize the invention, are pointed out with particularity in the drawings, detailed description, and claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a front perspective view of a device constructed in accordance with the teachings of the present disclosure.

FIG. 2 is a front perspective view of an alternative embodiment of a device constructed in accordance with the teachings of the present disclosure.

FIG. 3 is a top view of the device shown in FIG. 1.

FIG. 4 is a side view of the device shown in FIG. 1.

FIG. 5 is a rear perspective view of the device shown in FIG. 1.

FIG. 6 is an exploded perspective view of the device shown in FIG. 1.

FIG. 7 is a front perspective view of an adapter constructed in accordance with the teachings of the present disclosure.

FIG. 8 is a rear perspective view of the adapter shown in FIG. 7.

FIG. 9 is a rear perspective view of an adapter constructed in accordance with the teachings of the present disclosure.

FIG. 10 is a front perspective view of an adapter constructed in accordance with the teachings of the present disclosure, wherein the adapter is connected to a chemical tank.

### DETAILED DESCRIPTION OF ILLUSTRATIVE EMBODIMENTS

The terms “top,” “bottom,” “front,” and “rear” are used in the specification to describe the embodiments of the invention as illustrated in the accompanying Figures. It should be appreciated that in actual use, an embodiment of the invention may be rotated as needed to accomplish the objectives of the invention. As a result of such rotation, the various terms used herein of “top,” “bottom,” “front,” “rear,” and the like may not literally apply to a particular arrangement. Such terms are relative and are used herein to describe the Figures for illustration purposes only and are not intended to limit the embodiments shown to any particular orientation.

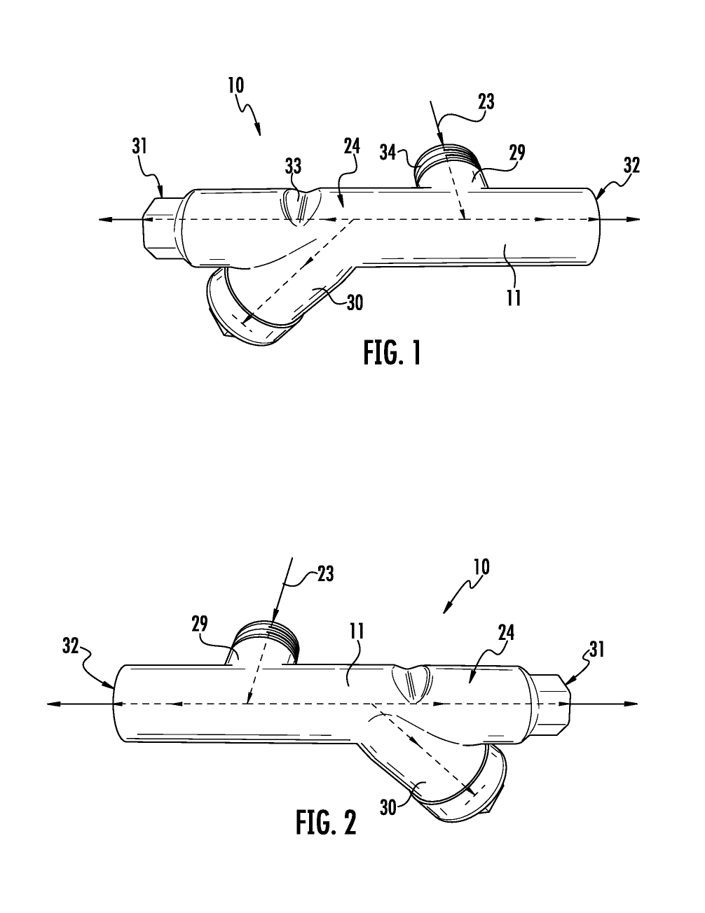

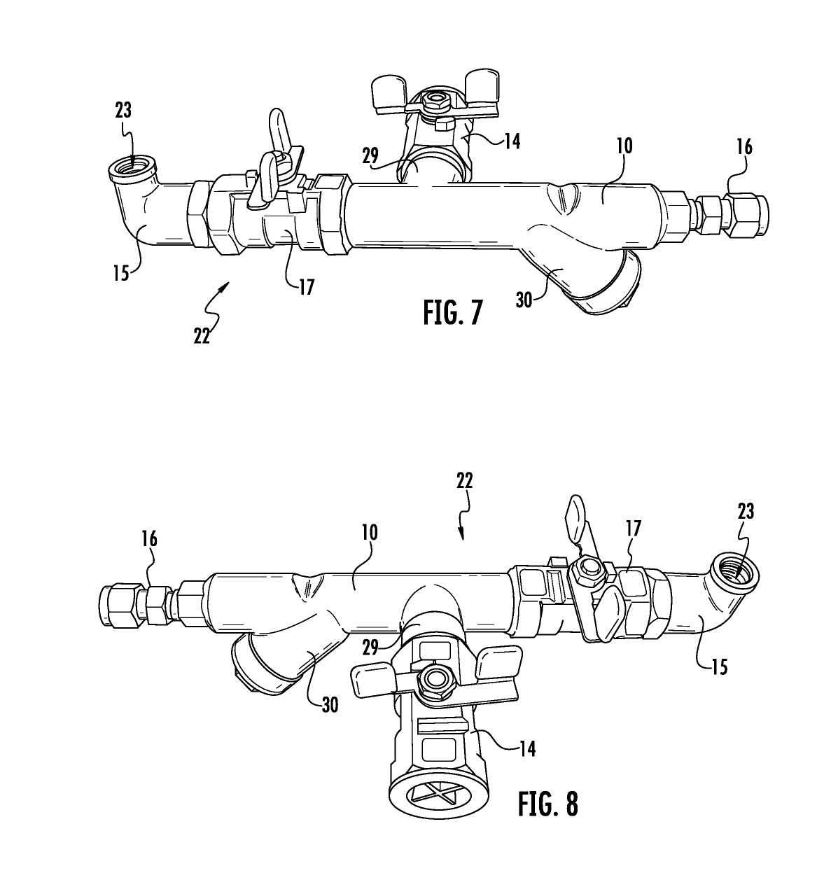

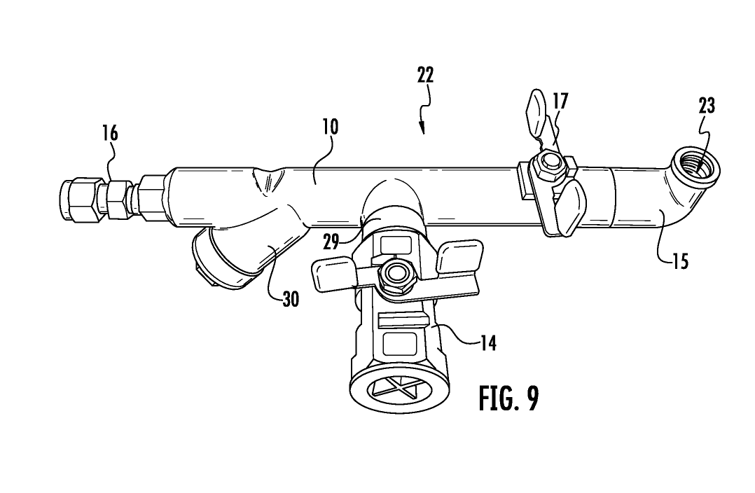

Referring now to FIGS. 1-10, exemplary embodiments of a chemical tank adapter 22 and methods of use in accordance with the present disclosure are illustrated. The chemical tank adapter 22 is configured to fluidly connect a chemical injection system to a chemical tank 20, and generally includes a connection member 10, one or more valves (14, 17), and an elbow member 15.

As illustrated in FIGS. 1-6, the chemical tank adapter 22 according to the present disclosure includes a novel connection member 10. This novel one-piece member 10 includes a body 11 having a front face 25, a rear face 26, a top face 27, and a bottom face 28. The body 11 comprises a cylindrical wall 24 encircling a fluid passageway 23 extending therethrough.

The connection member 10 further comprises a first arm 29 extending perpendicularly from the rear face 26 of the body 11. The first arm 29 comprises a cylindrical wall 39 and a connection means 34 for connecting the first arm 29 to a valve 14. The connection means 34 may be defined as a threaded end, as illustrated in the attached Figures. Alternatively, the first arm 29 may be connected to the valve 14 in a manner to eliminate the threaded connection point, such as by welding or molding the valve 14 to the first arm 29. The fluid passageway 23 extending through the body 11 further extends through the first arm 29 so that the fluid passageway 23 forms a T-shape, or an inverted T-shape, when viewed from the top view of the device 10, as illustrated in FIG. 3.

The connection member 10 further comprises a second arm 30 extending obliquely from the bottom face 28 of the body 11. The second arm 30 comprises a substantially cylindrical wall 40 and a filter outlet 38 for removing a filter 12 disposed within said second arm 30. The fluid passageway 23, which extends through the body 11 and the first arm 29, further extends through the second arm 30. When viewed from the front view of the device 10, the fluid passageway 23 forms a Y-shape, as shown in FIG. 4.

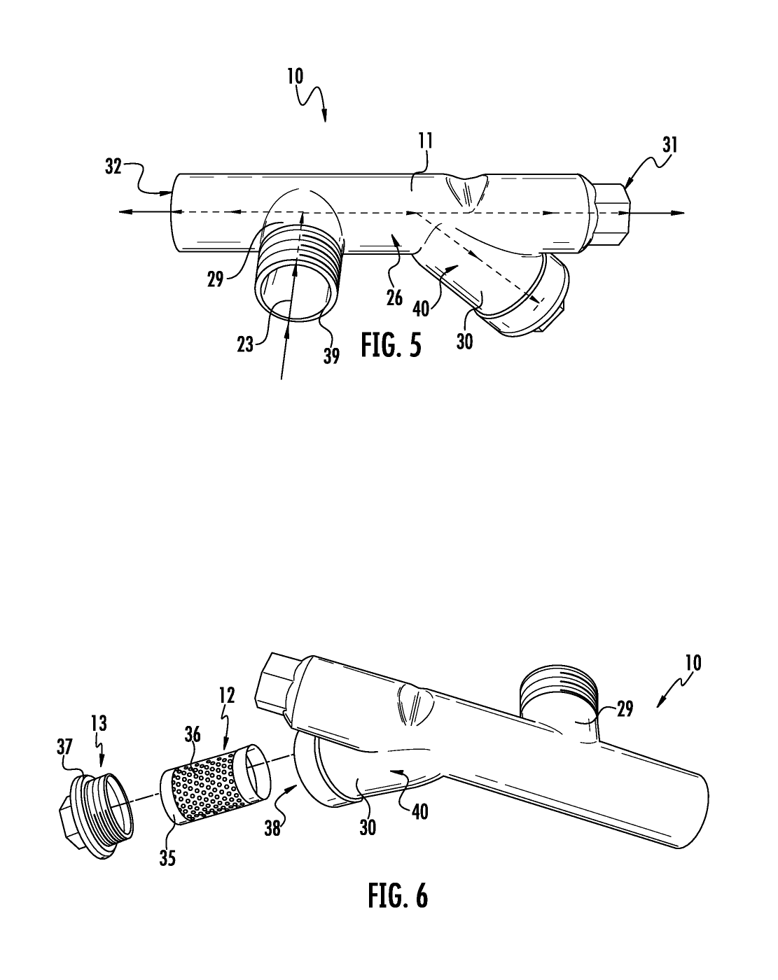

As depicted in FIG. 6, the second arm 30 includes a filter 12 disposed therein. The filter 12 is removably positioned inside the second arm 30 and extends into the fluid passageway 23 that is formed through the body 11. The filter is arranged and configured so that fluid flowing from the first arm 29 or the second end 32 of the body 11 to the first end 31 of the body 11 must first flow through the filter 12 before flowing through the first end 31 of the body 11 towards the chemical injection pump.

In the embodiment depicted in FIG. 6, the filter 12 includes a frame 35, on which is mounted one or more layers of mesh 36 or the like having openings of selected size adapted to pass fluids flowing through the adapter 22 while simultaneously filtering out particulates, dirt, and other unwanted material in the fluid traversing the filter 12. The filter 12 is used to remove particulates that could clog or damage the chemical injection pump when the chemicals flow through the chemical injection pump. As chemicals flow through the fluid passageway 23 towards the first end 31 of the body 11, the filter 12 catches and traps any particulates flowing with the fluid such that the fluid flowing through the first end 31 of the body 11 towards the chemical injection pump is essentially particulate-free. Over time, the particulates accumulate in the filter 12, at which time the particulates can be purged from the filter 12 by removing the filter 12 from the filter outlet 38 of the second arm 30 for cleaning or replacement.

FIG. 6 shows one embodiment of a filter 12 that may be used with the disclosed connection member 10. The filter 12 may be cylindrical in shape, as illustrated, or it may be configured in any other shape suitable for fitting inside the second arm 30 and removing particulates from fluids flowing through the connection member 10. Those skilled in the art will recognize that many variations of filters may be utilized with the disclosed adapter 22, all of which are considered to be within the spirit and scope of the present invention.

As depicted in the attached Figures, the second arm 30 includes a member for releasably sealing off the filter outlet, such as a plug 13 or the like, to prevent chemicals from flowing out through the filter outlet 38 of the second arm 30. As shown in FIG. 6, the second arm 30 may include internal female threads for mating with external male threads on a plug 13 threadably engaged with the second arm 30. An O-ring seal 37 may be attached to the plug 13 in order to prevent leakage between the second arm 30 and the plug 13. Alternatively, the second arm 30 may include external male threads for mating with internal female threads on a cap threadably engaged with the second arm 30. Additionally, other means for releasably sealing off the filter outlet 38 of the second arm 30 may be used and are considered to be within the spirit and scope of the present invention. To purge the filter 12 of particulates, dirt, and other unwanted material, the member (e.g., the plug 13) for releasably sealing off the filter outlet 38 may be disengaged from the second arm 30 and the filter 12 may be removed and replaced or cleaned.

In a preferred embodiment, the cylindrical walls (24, 39, and 40, respectively) forming the body 11, the first arm 29, and the second arm 30 of the connection member 10, are thinner and, thus, are made with less material compared to the walls of conventional pipe fittings. For example, in one embodiment contemplated by the present disclosure, the walls (24, 39, and 40) are approximately 0.110 inches thick. In comparison, the walls of typical prior art fittings are at least 0.165 inches thick. Decreasing the thickness of the walls, significantly reduces the weight of the device and decreases production costs by reducing the amount of material used to make the adapter 22. Furthermore, in order to further decrease the weight of the device 10 and to decrease the amount of material required to make the device 10, the connection member 10 may include one or more indentations 33 in the body 11, as shown in the attached Figures.

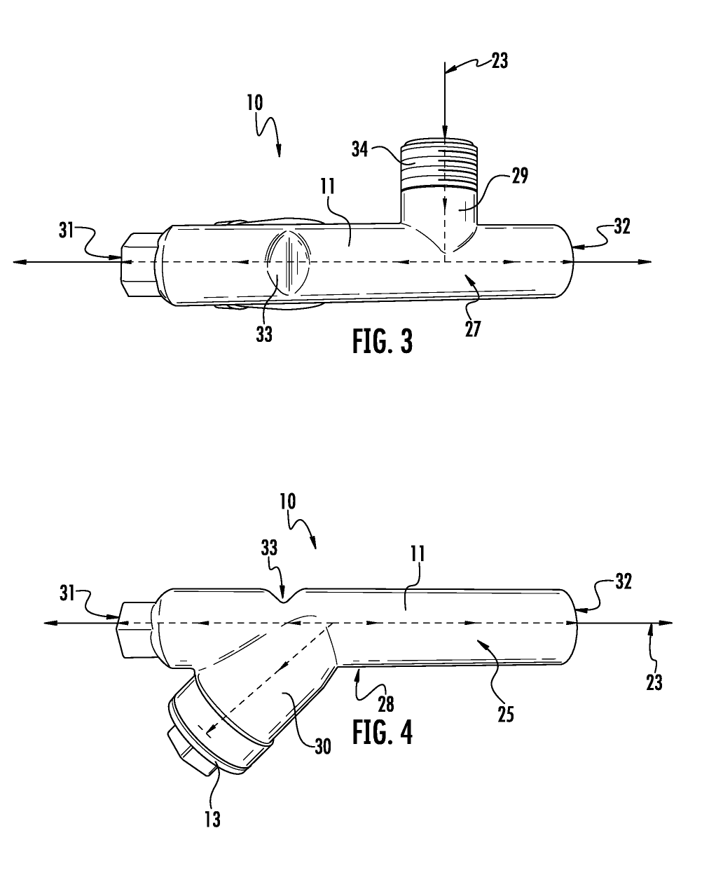

As shown in FIGS. 1-2, two alternative embodiments of the disclosed connection member 10 are depicted. FIG. 1 shows a left-handed connection member 10 wherein the hose or tubing 19, which connects the connection member 10 to the chemical injection pump (not illustrated), would be connected to the first end 31 of the connection member 10 located on the left side of the connection member 10. FIG. 2 shows a right-handed connection member 10 wherein the hose or tubing 19, which connects the connection member 10 to the chemical injection pump, would be connected to the first end 31 of the connection member 10 located on the right side of the connection member 10. One skilled in the art can appreciate that there are other possibilities that exist for changing the configuration of the connection member 10, all of which are considered to be within the spirit and scope of the present invention.

Turning to FIGS. 7-10, the second end 32 of the connection member 10 is joined to a valve 17 (e.g., a quarter-turn ball valve or the like used for isolation purposes) and the valve is joined to an elbow member 15, in order to form the one-piece chemical tank adapter 22 disclosed herein. Preferably, the valve 17 is molded to the second end 32 of the connection member 10, as illustrated in FIG. 9. Alternatively, the valve 17 may be welded, threaded, or connected to the connection member 10 using any means known to those skilled in the art. Likewise, the elbow member 15 may be welded, threaded or connected to the valve member 17 using any means known to those skilled in the art.

The elbow member 15 is configured to connect to a gauge device 18 (e.g., a pump setting gauge, a level gauge, or the like), which may be used to periodically monitor the performance and accuracy of the chemical injection pump system. As illustrated in FIGS. 7-9, the elbow member 15 may include a threaded end for threadably engaging a threaded coupling on the gauge device 18, which is a standard part on gauge devices 18. Alternatively, the elbow member 15 may include any means for connecting the elbow member to the gauge device 18 known by those skilled in the art.

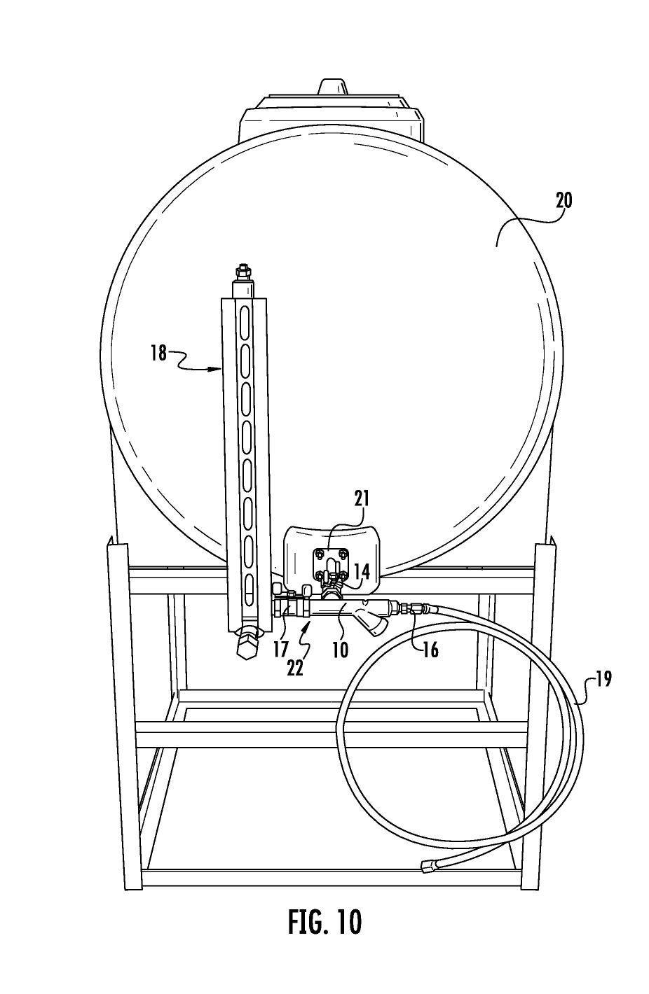

In the embodiment depicted in FIG. 10, the chemical tank adapter 22 is shown connected to a chemical tank 20, a gauge device 18, and a hose or tubing 19, which connects the adapter 22 to the chemical injection pump (not illustrated). The tank 20 includes a bulkhead fitting 21 attached thereto. A tank valve 14, such as a quarter-turn ball valve, is connected to the bulkhead fitting 21. As described above, the first arm 29 of the connection member 10 comprises a connection means 34 for connecting the first arm 29 to the tank valve 14, such as a threaded end for threadably connecting the first arm 29 to the tank valve 14.

Once the adapter 22 has been connected to the tank valve 14, a gauge device 18 may be attached to the elbow member 15 disposed on one end of the adapter 22. Typically, the gauge device 18 can be threadably connected to the elbow member 15.

Finally, the first end 31 of the connection member 10 includes a means (e.g., a threaded end) for connecting the adapter 22 to a hose fitting 16 or the like. Once the hose fitting 16 has been connected to the first end 31 of the connection member 10, a hose 19 or the like is then connected to the hose fitting 16 and a chemical injection pump (not illustrated) is connected to the hose 19.

In one of the embodiments contemplated by the present disclosure, the chemical tank adapter 22 disclosed herein is made of stainless steel. In alternative embodiments, the adapter 22 may be made of other suitable, chemical-resistant materials and may be provided in various sizes suitable for connecting a chemical tank 20 to a chemical injection pump system as disclosed herein.

It is important to note that the construction and arrangement of the elements of the adapter provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Though the disclosed adapter is illustrated in the accompanying Figures and described with its application for use with chemical tanks in the oil and gas industry, note that it is not intended to limit the spirit and scope of the present invention solely for use with chemical tanks in the oil and gas industry. As will be appreciated by those skilled in the art, the disclosed device may be utilized in a wide range of applications in place of threaded pipe fittings.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other uses, features, modifications and variations are, therefore, considered to be a part of this invention, the scope of which is to be determined by the following claims.

The invention claimed is:

1. An adapter, comprising:
a connection member, said connection member comprising
a body including a cylindrical wall, said body having a front face, a rear face, a top face, and a bottom face;
a first arm including a cylindrical wall, wherein said first arm extends perpendicularly from said rear face of said body; and
a second arm including a substantially cylindrical wall, wherein said second arm extends obliquely from said bottom face of said body,
wherein a fluid passageway extends through said cylindrical walls of said body, said first arm and said second arm.

2. The adapter according to claim 1, wherein said adapter is arranged and configured to fluidly connect a chemical injection pump system to a chemical tank.

3. The adapter according to claim 1, wherein said second arm further includes a filter disposed within said second arm, and wherein said filter extends into the fluid passageway that is formed through said body.

4. The adapter according to claim 3, wherein said filter is arranged and configured to pass fluids flowing through said adapter while simultaneously filtering out particulates before the fluids flow through a chemical injection pump fluidly connected to said adapter.

5. The adapter according to claim 3, wherein said second arm further includes a filter outlet for removing said filter disposed within said second arm.

6. The adapter according to claim 5, wherein said filter outlet includes a member for releasably sealing off said filter outlet, said member for releasably sealing off said filter outlet being arranged and configured to prevent fluids from flowing out through said filter outlet.

7. The adapter according to claim 6, wherein said member for releasably sealing off said filter outlet includes a plug arranged and configured to prevent fluids from flowing out through said filter outlet.

8. The adapter according to claim 1, wherein said cylindrical walls of said body, said first arm and said second arm are less than 0.165 inches thick.

9. The adapter according to claim 1, wherein said cylindrical walls of said body, said first arm and said second arm are 0.110 inches thick.

10. The adapter according to claim 1, wherein said body of said connection member further includes one or more indentations.

11. The adapter according to claim 1, wherein said connection member further comprises:
a first end configured to connect said adapter to a hose, which fluidly connects the adapter to a chemical injection pump; and
a second end for joining said connection member with a valve.

12. The adapter according to claim 11, wherein said valve is a quarter-turn ball valve.

13. The adapter according to claim 11, wherein said valve is molded to said second end of said connection member.

14. The adapter according to claim 11, wherein said valve is welded to said second end of said connection member.

15. The adapter according to claim 11, wherein said valve is threadably connected to said second end of said connection member.

16. The adapter according to claim 11, further comprising an elbow member joined to said valve.

17. The adapter according to claim 16, wherein said elbow member is welded to said valve.

18. The adapter according to claim 16, wherein said elbow member is threadably connected to said valve.

19. The adapter according to claim 16, wherein said elbow member is configured to connect said adapter to a gauge device.

20. The adapter according to claim 16, wherein said adapter fluidly connects a chemical tank to a gauge device and to a hose configured to connect the adapter to a chemical injection pump.

21. The adapter according to claim 16, wherein said adapter fluidly connects a chemical tank to a chemical injection pump and further includes:
a bulkhead fitting attached to said tank;
a tank valve connected to said bulkhead fitting;
said first arm of the connection member connected to said tank valve;
a gauge device connected to said elbow member;
a hose connected to said connection member; and
a chemical injection pump connected to said hose.

22. The adapter according to claim 16, wherein said adapter is used for a method of connecting a chemical tank to a chemical injection pump, said method comprising the following steps:
connecting a tank valve to a bulkhead fitting attached to said chemical tank;
connecting said first arm of said adapter to said tank valve;
connecting a gauge device to said elbow member of said adapter;
connecting a hose to said first end of the connection member of said adapter; and
connecting a chemical injection pump to said hose.
